(19) United States
(12) Patent Application Publication
(10) Pub. No.: US 2011/0018828 A1
(43) Pub. Date: Jan. 27, 2011

(54) TOUCH DEVICE, CONTROL METHOD AND CONTROL UNIT FOR MULTI-TOUCH ENVIRONMENT

(75) Inventors: DENG-JING WU, TAINAN COUNTY (TW); HSUEH-WEI YANG, HSINCHU COUNTY (TW); YU-JEN TSAI, HSINCHU CITY (TW); HSIAO-HUA TSAI, HSINCHU COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: ELAN MICROELECTRONICS CORPORATION, HSINCHU (TW)

(21) Appl. No.: 12/839,626

(22) Filed: Jul. 20, 2010

Related U.S. Application Data
(60) Provisional application No. 61/227,505, filed on Jul. 22, 2009.

(51) Int. Cl. G06F 3/041

(52) U.S. Cl. 345/173

(57) ABSTRACT

A touch device for multi-touch environment generates a sensing signal in response to an object touch thereon, generates an event signal according to the sensing signal and a control signal, generates a cursor signal according to coordinate information of each touch point contained in the sensing signal and the event signal, and transmits the cursor signal and the event signal to the multi-touch environment. The cursor signal is used to control a cursor application to show a cursor at a screen for each touch point and changes appearances of the cursors. The cursors clearly inform a user of locations where his/her fingers correspond on the screen. By conducting touch events in the multi-touch environment through the cursors instead of actual fingers, the user can operate the touch device other than a touch screen in a multi-touch manner as operating a multi-touch screen.

### CROSS REFERENCE TO RELATED APPLICATIONS

This application claims the benefit of U.S. Provisional Application No. 61/227,505, filed on Jul. 22, 2009.

### FIELD OF THE INVENTION

The present invention is related generally to a touch device and, more particularly, to a touch device for multi-touch environment.

### BACKGROUND OF THE INVENTION

The developing touch technology has realized, in addition to the conventional small-size touch screens for portable devices, the operating environments (operating systems) supporting multi-touch screens, such as Windows 7 from Microsoft and iPhone OS from Apple, which allow large-size touch screens to be used for stationary devices and thereby allow users' intuitive operation through the touch screens. In a conventional system, as shown in FIG. 1, a multi-touch screen 12 directly generates an event signal, which is then packed by a multi-touch event transmitter 14 into a touch-event package recognizable to a multi-touch environment 16, and the touch-event package is sent to a multi-touch event receiver 18 in the multi-touch environment 16. The multi-touch environment 16 operates according to commands from the event signal to display a result on the multi-touch screen 12. For instance, the operating system Windows 7 identifies touch events as three different kinds, namely “down”, “up” and “move” corresponding to user's finger movements with respect to the multi-touch screen 12, namely contacting, leaving and moving, respectively. Therein, each touch event contains information including coordinate point identification, coordinate location and time stamp.

While the multi-touch environments are now mature, there are shortcomings related to large-size touch screens, such as the high costs of the hardware and the operation requests users to stay before the screens. As to touch devices other than touch screens, the operation by users' fingers is not conducted directly on their screens, so contact of the fingers to the touch devices is unable to directly control objects displayed on the screens. Therefore, it is desired a touch device other than a touch screen for multi-touch environment

### SUMMARY OF THE INVENTION

An object of the present invention is to provide a touch device for multi-touch environment.

Another object of the present invention is to provide a control method for multi-touch environment.

Another object of the present invention is to provide a control unit for multi-touch environment.

According to the present invention, a touch device for multi-touch environment includes a multi-touch sensor to generate a sensing signal that contains coordinate information of each touch point in response to an object touch thereon, a multi-touch event decision unit to generate an event signal according to the sensing signal and a control signal, a cursor display control unit to generate a cursor signal according to the coordinate information and the event signal to send to the multi-touch environment, and a multi-touch event transmitter to transmit the event signal to the multi-touch environment.

According to the present invention, a control method for multi-touch environment includes generating a sensing signal that contains coordinate information of each touch point in response to an object touch, generating an event signal according to the sensing signal and a control signal, generating a cursor signal according to the coordinate information and the event signal, and sending the cursor signal and the event signal to the multi-touch environment.

According to the present invention, a control unit for multi-touch environment includes a multi-touch event decision unit to generate an event signal according to a sensing signal and a control signal, a cursor display control unit to generate a cursor signal according to coordinate information of each touch point contained in the sensing signal and the event signal to send to the multi-touch environment, and a multi-touch event transmitter to send the event signal to the multi-touch environment.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a systematic configuration of a conventional multi-touch screen in multi-touch environment;

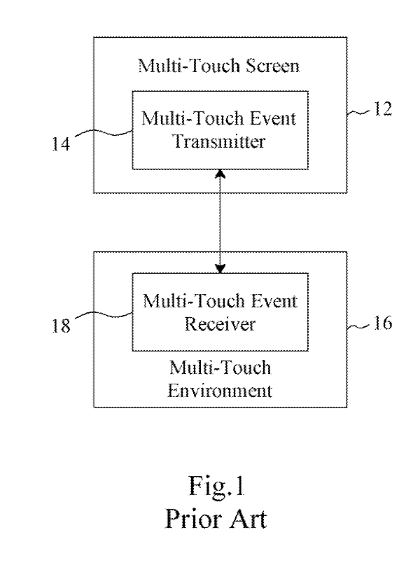

FIG. 2 shows a systematic configuration of a touch device for multi-touch environment according to the present invention;

FIG. 3 illustrates generation of a control signal according to a first embodiment of the present invention;

FIG. 4 illustrates generation of a control signal according to a second embodiment of the present invention;

FIG. 5 is a flowchart describing generation of an event signal in the embodiments of FIGS. 3 and 4;

FIG. 6 illustrates generation of a control signal according to a third embodiment of the present invention;

FIG. 7 is a flowchart describing determination of a single-touch in the embodiment of FIG. 6; and

FIG. 8 is a flowchart describing generation of an event signal in the embodiment of FIG. 6.

### DETAILED DESCRIPTION OF THE INVENTION

A touch device according to the present invention can simulate intuitive operation as fingers performing at a multi-touch screen, and thereby substitute for costly multi-touch screens. The touch device may be one installed on a notebook computer or an external peripheral device. By communicating with multi-touch environment via wireless transmission technology, the touch device frees its user from being bound before the screen of the computer. When operated by multiple fingers, the touch device transmits to the multi-touch environment a touch event recognizable thereto, so that the touch event according to default definitions in the multi-touch environment to scale-up, scale-down, move or rotate an object presented on the screen.

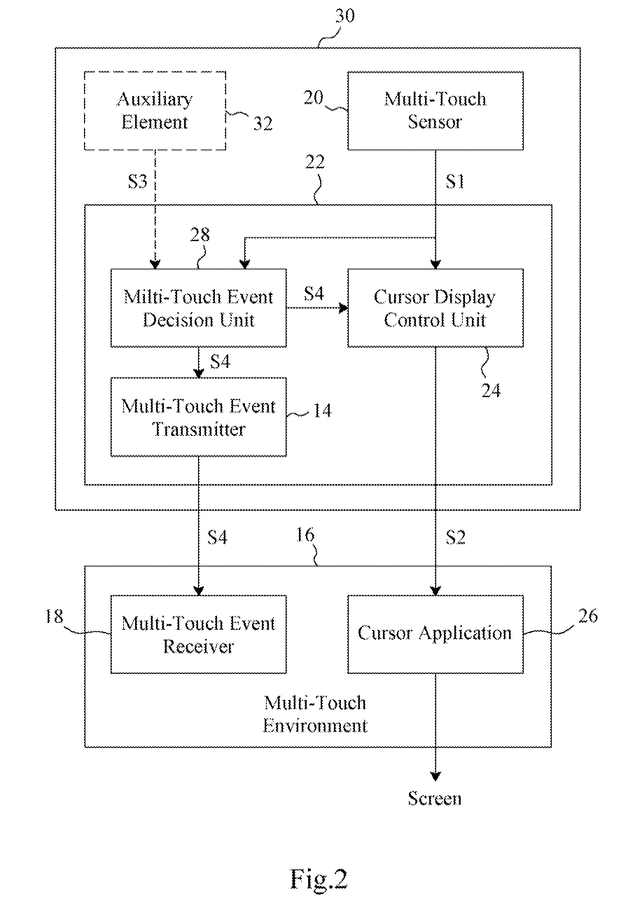

FIG. 2 shows a systematic configuration of a touch device 30 for multi-touch environment 16 according to the present invention. The touch device 30 has a multi-touch sensor 20 for generating a sensing signal S1 for a control unit 22. The sensing signal S1 contains coordinate information of each touch point. In the control unit 22, a cursor display control unit 24 generates a cursor signal S2 according to the coordinate information of the touch points contained in the sensing signal S1 and sends the cursor signal S2 to a cursor application 26 in the multi-touch environment 16, so as to display a cursor for each touch point on the screen. Each said cursor represents a virtual finger of the user, and thus the cursors clearly inform the user of locations where his/her each finger corresponds on the screen. The cursors are not traditional mouse cursors. After a preset period any finger leaving the touch device 30, the corresponding cursor is automatically hidden. In addition, an auxiliary element 32 provides a control signal S3 to the control unit 22, so a multi-touch event decision unit 28 determines an event signal S4 according to the coordinate information of each said touch point contained in the sensing signal S1 and the control signal S3. The event signal S4 is converted by the multi-touch event transmitter 14 into a touch event recognizable to the multi-touch environment 16 and sent to a multi-touch event receiver 18. The event signal S4 is also sent to the cursor display control unit 24, wherein the latter presents various appearances of the cursors on the screen according to the event signal S4. The various appearances of the cursors may be composed of different colors and shapes, so as to simulate the states the users' fingers on the screen, thereby facilitating the user's accurate operation in the multi-touch environment 16. In the multi-touch environment 16, according to the signals S2 and S4 from the control unit 22, the cursors are presented to simulate the actual human fingers to perform touch events in the multi-touch environment 16. In some embodiments, the control signal S3 is determined by the multi-touch event decision unit 28 according to the information contained in the sensing signal S1, instead of provided by the auxiliary element 32. In some embodiments, the auxiliary element 32 is not a part of the touch device 30, but an external device outside the touch device 30.

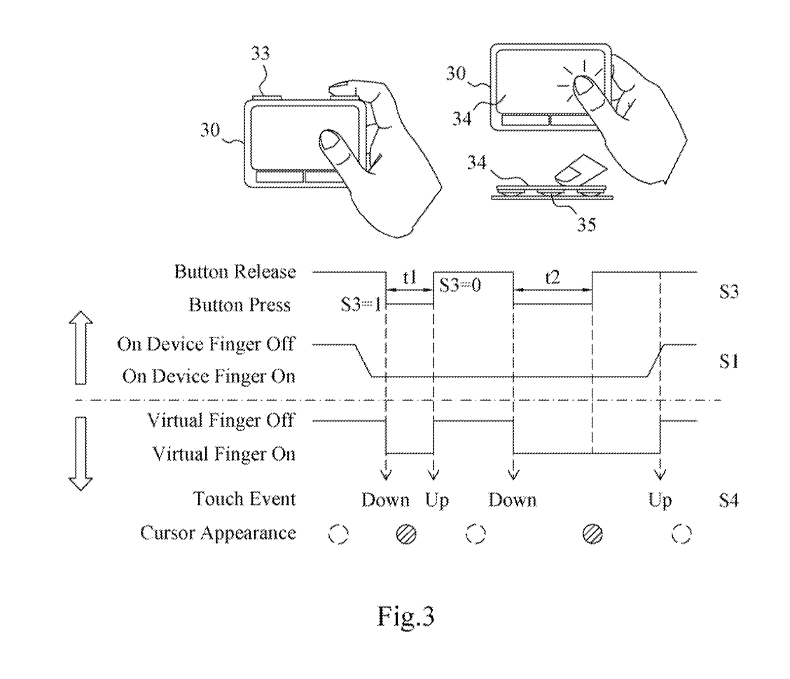

FIG. 3 illustrates generation of the control signal S3 according to a first embodiment, in which the auxiliary element 32 is a button 33 positioned atop the touch device 30 or a button 35 positioned under a touch panel 34. When the button 33 or 35 is pressed, the control signal S3 is equal to logical 1; on the contrary, when the button 33 or 35 is released, the control signal S3 is equal to logical 0. The multi-touch event decision unit 28 generates the event signal S4 according to the control signal S3 and the sensing signal S1, and then the cursor display control unit 24, according to the event signal S4, presents various cursor appearances on the screen to show the state of the virtual finger on the screen. In this embodiment, when the event signal S4 reflects a “down” event, the cursor on the screen becomes a solid circle from a dotted circle, as the virtual finger touches the screen. Afterward, when the event signal S4 reflects an “up” event, the cursor on the screen turns back to the dotted circle from the solid circle, as the virtual finger leaves the screen. After a preset period from the finger leaving the touch device 30, the cursor is automatically hidden (not shown in FIG. 3).

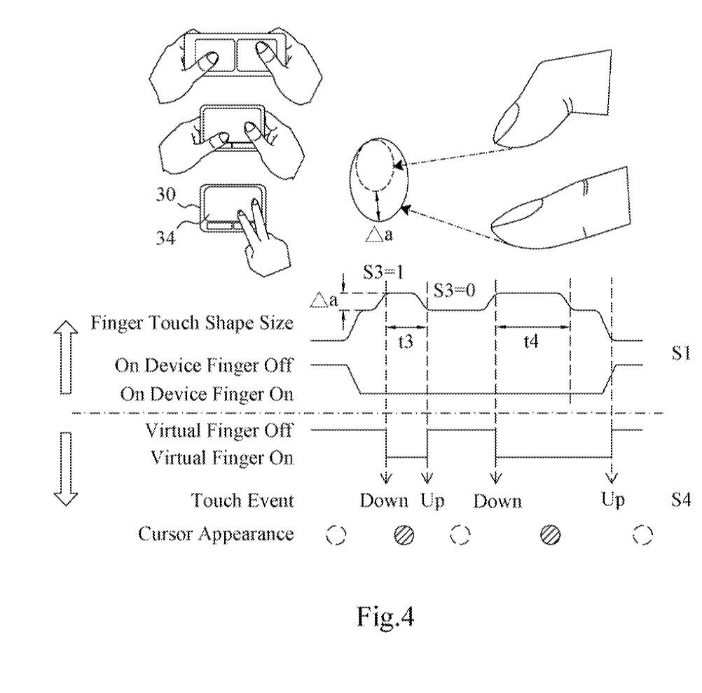

FIG. 4 illustrates generation of the control signal S3 according to a second embodiment. The sensing signal S1 generated by the multi-touch sensor 20 contains the finger touch shape size of each touch point on the touch panel 34. In this embodiment, a variation Δa of the finger touch shape size of each touch point is adopted for generating the control signal S3. As shown in the upper right part of FIG. 4, the user may create a variation Δa of the finger touch shape size by changing his/her finger gesture. The multi-touch event decision unit 28 determines the control signal S3 according to the variation Δa of the finger touch shape size in the sensing signal S1. When the finger touch shape size increases in excess of a predetermined value, the control signal S3 is equal to logical 1, whereas when the touched area decreases in excess of a predetermined value, the control signal S3 is equal to logical 0.

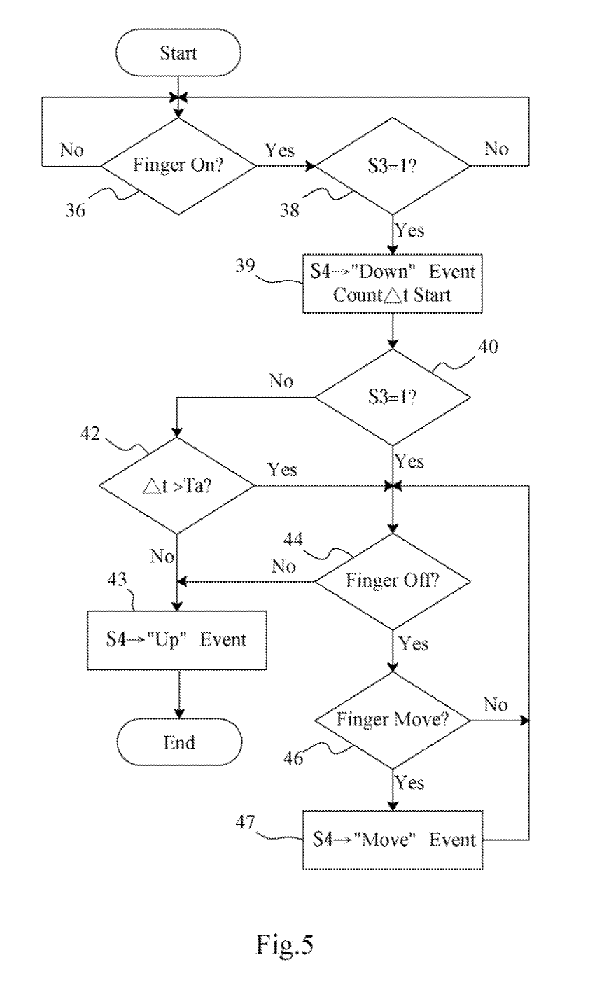

FIG. 5 is a flowchart showing generation of the event signal S4 according to the embodiments of FIGS. 3 and 4. In illustration, the operating system Windows 7 is herein taken for example. First, in step 36, it is detected any finger on the touch panel 34. If the touch panel 34 is touched, step 38 is performed to check whether the control signal S3 is equal to logical 1. If the control signal S3 is equal to logical 1, step 39 generates the event signal S4 as a “down” event and starts to count a time Δt. Step 40 monitors the state of the control signal S3. If the control signal S3 turns back to logical 0, step 42 is performed to check whether Δt is in excess of a predetermined value Ta. The time Δt herein is the time elapsing for the control signal S3 to return to logical 0 from logical 1. If the time Δt is not in excess of the predetermined value Ta, as t1 in FIG. 3 and t3 in FIG. 4, step 43 generates the event signal S4 as an “up” event. If the time Δt is in excess of the predetermined value Ta, as t2 in FIGS. 3 and t4 in FIG. 4, step 44 checks whether the finger has left the touch panel 34. If the finger has left the touch panel 34, the process goes back to step 43 to generate the event signal S4 as an “up” event. If the finger still stays on the touch panel 34, step 46 is performed to check whether the finger is moving on the touch panel 34. If the finger is not moving, the process goes back to step 44; otherwise, step 47 is performed to generate the event signal S4 as a “move” event and then the process goes back to step 44.

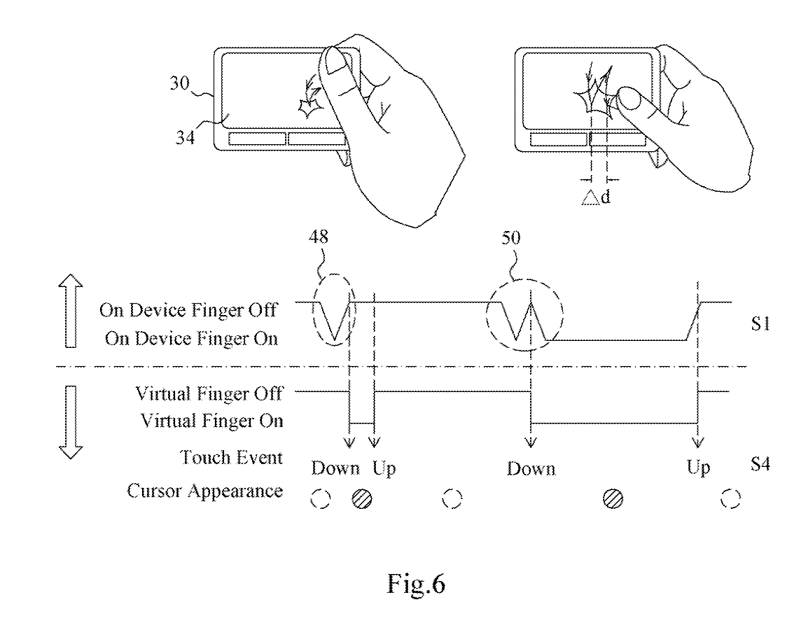

FIG. 6 is based on a third embodiment of generation of the control signal S3. The sensing signal S1 generated by the multi-touch sensor 20 contains information about locations and touch times of each said touch point on the touch panel 34, so as to allow determination of finger gestures on the touch panel 34, which in turn allows determination of the control signal S3. In this embodiment, the touch gesture may be a click 48 or a double click 50 performed on the touch panel 34. The click 48 is achieved by contacting the touch panel 34 and leaving with a predetermined time Tb, and the double click 50 is achieved by following the click 48 with another contact of touch panel 34 within a predetermined time Tc, wherein a distance Δd between the touch point of the subsequent contact and the touch point of the click 48 is smaller than a threshold Da. When the user conducts a click 48, the multi-touch event decision unit 28 temporarily set the control signal S3 as logical 1. In the case of the double click 50, the control signal S3 remains logical 1, and once the finger leaves the touch panel 34, the control signal S3 returns to logical 0.

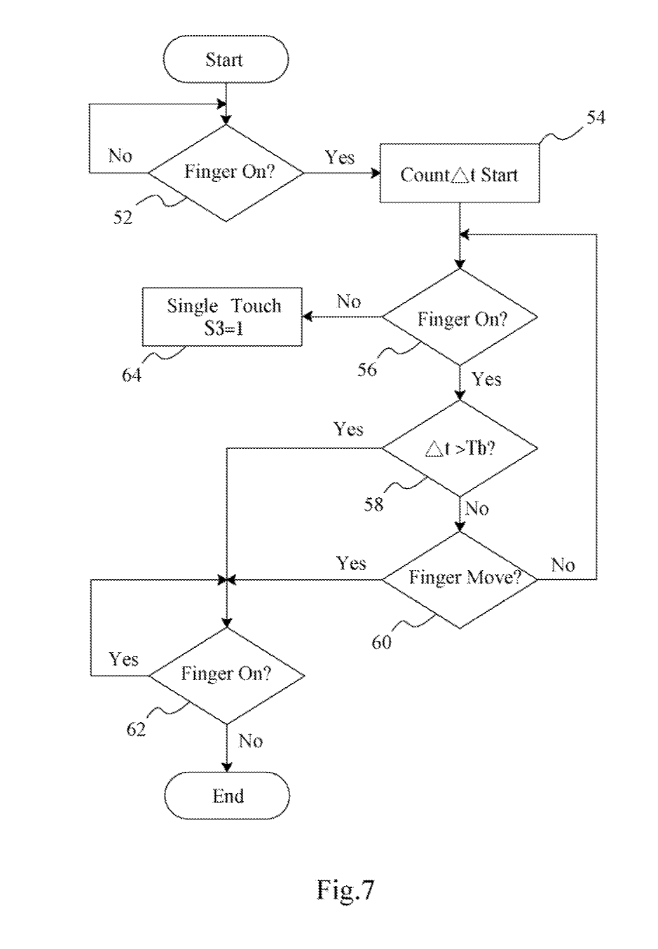

FIG. 7 is a flowchart of determination of the click according to the embodiment of FIG. 6. After step 52 confirms the presence of a finger on the touch panel 34, step 54 starts to count the time Δt where the finger is placed on the touch panel 34 and stops counting when step 56 detects that the finger leaves the touch panel 34. Otherwise, step 58 compares the time Δt and the predetermined value Tb. Step 60 detects whether the finger is moving. If the time Δt is in excess of the predetermined value Tb or if the finger has moved, the process of click determination is finished after step 62 confirms that the finger leaves the touch panel 34.

If the finger stays still within the time Tb, after step 56 confirms that the finger leaves the touch panel 34, step 64 identifies the touch gesture as a click, so as to set the control signal S3=1.

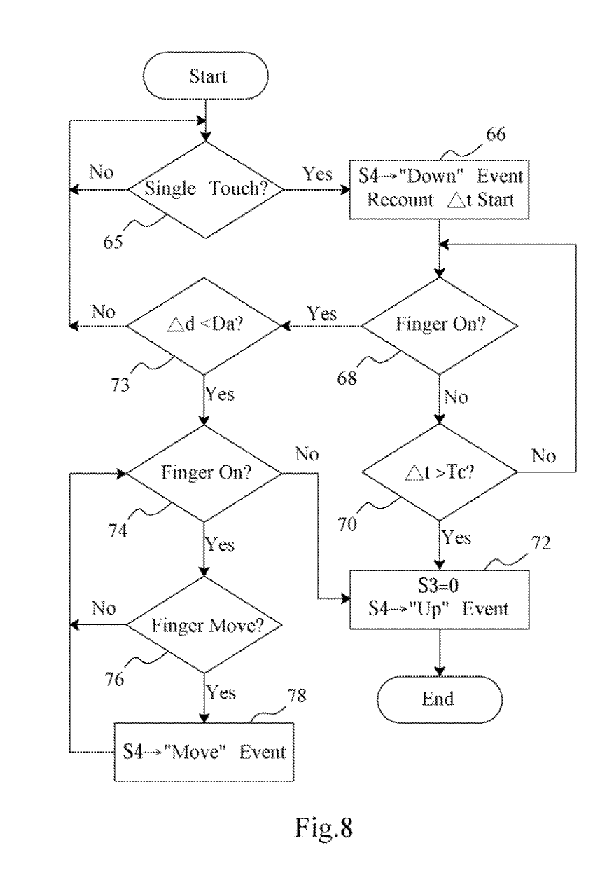

FIG. 8 is a flowchart of generation of the event signal S4 according to the embodiment of FIG. 6. Step 65 detects whether the touch gesture includes a click in the manner shown in FIG. 7. If the touch gesture includes a click, step 66 generates the event signal S4 as a “down” event and restarts to count the time Δt where the finger retouches the touch panel 34. The time Δt herein is the time elapsing from the finger's leaving to its retouching the touch panel 34. If step 68 confirms that the finger leaves the touch panel 34, and step 70 identifies the time Δt as greater than the predetermined value Tc, step 72 changes the control signal S3 to logical 0 and generates the event signal S4 as an “up” event. If step 68 detects that the finger contacts the touch panel 34 within the time Tc, step 73 is performed to detect the distance Δd between the touch point of the subsequent contact and the touch point of the click being greater or smaller than the threshold Da. If the distance Δd is greater, the process returns to step 65 to determine whether the present touch gesture includes a click. If the distance Δd is smaller, the touch gesture is identified as a double click, so step 74 is conducted to check whether the finger leaves the touch panel 34. If the finger has left the touch panel 34, the process goes to step 72 to generate the event signal S4 as an “up” event. If the finger stays on the touch panel 34, the process goes to step 76 to check whether the finger is moving on the touch panel 34. If the finger stays still, the process returns to step 74; otherwise, the process proceeds by performing step 78 to generate the event signal S4 as a “move” event before going back to step 74.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A touch device for multi-touch environment, comprising:
a multi-touch sensor operative to generate a sensing signal that contains coordinate information of each touch point in response to an object touch thereon;
a multi-touch event decision unit connected to the multi-touch sensor, operative to generate an event signal according to the sensing signal and a control signal;
a cursor display control unit connected to the multi-touch sensor and the multi-touch event decision unit, operative to generate a cursor signal according to the coordinate information and the event signal to send to the multi-touch environment; and
a multi-touch event transmitter connected to the multi-touch event decision unit, operative to transmit the event signal to the multi-touch environment.

2. The touch device of claim 1, further comprising an auxiliary element to provide the control signal.

3. The touch device of claim 2, wherein the auxiliary element comprises a button.

4. The touch device of claim 1, wherein the sensing signal further comprises a finger touch shape size of each touch point.

5. The touch device of claim 4, wherein the multi-touch event decision unit determines the control signal according to the finger touch shape size.

6. The touch device of claim 1, wherein the multi-touch event decision unit identifies a touch gesture according to the sensing signal to determine the control signal.

7. A control method for multi-touch environment, comprising the steps of:
generating a sensing signal that contains coordinate information of each touch point in response to an object touch;
generating an event signal according to the sensing signal and a control signal;
generating a cursor signal according to the coordinate information and the event signal; and
sending the cursor signal and the event signal to the multi-touch environment.

8. The control method of claim 7, further comprising the step of determining the control signal according to a finger touch shape size of each touch point contained in the sensing signal.

9. The control method of claim 7, further comprising the step of determining a touch gesture according to the sensing signal to determine the control signal.

10. The control method of claim 9, wherein the touch gesture comprises a click or a double click.

11. A control unit for multi-touch environment, comprising:
a multi-touch event decision unit operative to generate an event signal according to a sensing signal and a control signal;
a cursor display control unit connected to the multi-touch event decision unit, operative to generate a cursor signal according to coordinate information of each touch point contained in the sensing signal and the event signal to send to the multi-touch environment; and
a multi-touch event transmitter connected to the multi-touch event decision unit, operative to send the event signal to the multi-touch environment.

12. The control unit of claim 11, wherein the multi-touch event decision unit determines the control signal according to a finger touch shape size of each touch point contained in the sensing signal.

13. The control unit of claim 11, wherein the multi-touch event decision unit identifies a touch gesture according to the sensing signal to determine the control signal.

14. The control unit of claim 13, wherein the touch gesture comprises a click or a double click.
